(19) United States
(12) Patent Application Publication
(10) Pub. No.: US 2011/0057350 A1
(43) Pub. Date: Mar. 10, 2011

(54) Method and Device for Making a Reinforcement by Winding a Tape on Itself

(75) Inventors: Christophe Hombert, Clermont-Ferrand (FR); Daniel Goy, Cebazat (FR)

(73) Assignees: SOCIETE TECHNOLOGIE MICHELIN, Clemont -Ferrand (FR); Michelin Recherche et Technique S.S., Granges-Paccot (CH)

(21) Appl. No.: 12/866,029

(22) PCT Filed: Jan. 29, 2009
(86) PCT No.: PCT/EP09/50985

§ 371 Date: Nov. 22, 2010

(30) Foreign Application Priority Data
Feb. 4, 2008 (FR) 0850664

(51) Int. Cl. B29C 53/20; B29C 53/72; B29D 30/38

(52) U.S. Cl. 264/165; 425/89

(57) ABSTRACT

A device intended for creating a reinforcing strip formed by flattening a tube (t) comprising a first means for dispensing a tape (b) comprising an interleaf (D on one of its faces, at a given linear speed, and a second means comprising two rolls intended to flatten the said tube (t), in which device the said first and second means are able to be set in rotation relative to one another about an axis of rotation (XX′) parallel to the direction (p) in which the tape (b) progresses through the device, so that when the device is operating, the tape (b) is wound in a spiral on itself in contiguous turns to form a tube (t) the axis of which corresponds substantially to the axis (XX′) of rotation of the first means with respect to the second means, characterized in that it comprises a means (3) of calibrating the diameter of the tube (t) and positioned between the first and second means, and in that the said calibration means (3) rests against the exterior surface of the said tube (t), and a separation means (27) positioned downstream of the said second means and able to separate the said interleaf (I) from the surface of the flattened tube.

The invention relates to the field of the manufacture of tires intended to be fitted to wheeled vehicles, and more particularly to the step of manufacturing the reinforcements that are intended to be assembled with the other rubber components while the green tire is being built.

It is known practice in the prior art to position reinforcements in various parts of the tire. These reinforcements consist of threads coated with rubber compounds and make a given angle with the circumferential direction of the tire; hence reinforcements such as the carcass reinforcing plies which make an angle of 90° are said to be radial, and those which make a zero angle are known by the name of zero degrees reinforcements.

These reinforcements may be laid directly onto the green tire while it is being built or, more generally, may originate from intermediate products, in the form of plies, bands or tapes made up of reinforcements coated with rubber compound and in which the threads run parallel to one another while making an angle with the longitudinal direction of the strip, tape or ply.

The term thread is to be understood in an entirely general sense, encompassing a monofilament, a multifilament, a cord or folded yarn or equivalent assembly, and regardless as to whether the material of which the thread is made is of a textile or metallic nature.

The reinforcements to which the present description refers are reinforcing strips or plies that make an angle in excess of zero degrees with the longitudinal direction of the strip or the ply.

These reinforcing strips have the specific feature of being formed by flattening a tube, the said tube itself being formed by winding, in contiguous turns at given angle with respect to the longitudinal direction of the tube, a tape known as a straight thread tape, in which the threads are mutually parallel and parallel to the longitudinal direction of the tape, and coated in a rubber compound. The width of the tape is adjusted to suit the angle at which the turns are wound, so as to make the turns contiguous.

This then yields a reinforcing strip comprising two layers of superposed threads, in which strip the threads of one layer are mutually parallel and the threads of different layers make opposite angles with the longitudinal direction of the strip, and in which the threads run on continuously from one layer to another.

This type of reinforcement, and the methods of obtaining it, are described by way of example in publication FR 1 128 427, or alternatively in publications JP 10-217 352 or JP 10-217 353.

Publication FR 1 128 427 proposes winding a straight thread reinforcing tape around a cylindrical support to form a tube. The tube is then flattened between two rolls. However, it is found that the longitudinal tensions likely to arise in the strip cause the tube to bind on the cylindrical support and hamper the advance of the product and correct progress of the method.

Publication JP 10-217 352 discloses a device in which the straight thread reinforcing tape is wound about its longitudinal axis to form a tube, which tube is then compressed between two rolls to form a reinforcing strip. This device comprises a first means for dispensing the tape at a given linear speed and a second means comprising two rolls intended to flatten the tube. The second means is set in relative rotation with respect to the first means about an axis parallel to the direction in which the tape or the tube progresses through the device. The axis of rotation corresponds substantially to the axis of the tube itself. This device does, however, have the disadvantage of not allowing precise control over the angle of the threads or the edge-to-edge fit of the turns that make up the tube because there is no calibration means.

Publication JP 10-217 353 for its part proposes to produce a rubber tube by extrusion. The said unvulcanized rubber tube is then cooled to form a tube that is rigid enough that contiguous turns of thread can be wound around the exterior surface of the said tube at a given angle. The tube is then heated up and compressed between two cylinders to form the reinforcing tape. This method, which entails freezing the rubber tube to make it rigid, then heating it back up to give it the characteristics that allow it to be passed between the cylinders of the flattening cylinder device, has the disadvantage of consuming vast amounts of energy and of not being very productive given the time devoted to heat exchanges.

It is an object of the invention to improve the implementation of these devices.

The device according to the invention comprises a first means able to dispense a tape one of the faces of which has an interleaf sheet, and a second means comprising two rolls intended to flatten a tube. The first and second means are able to be set in rotation relative to one another about an axis of rotation parallel to the direction in which the tape progresses through the device, so that when the device is operating, the tape is wound in a spiral on itself in contiguous turns thus forming a tube the axis of which corresponds substantially to the axis of rotation of the first means with respect to the second means. This device is characterized in that it comprises a means of calibrating the diameter of the tube and positioned between the first and second means, and in that the said calibration means rests against the exterior surface of the said tube on which surface the said interleaf is positioned, and a separation means positioned downstream of the said second means and able to separate the said interleaf from the surface of the flattened tube.

It has been demonstrated that by making the calibrating device rest against the external surface of the tube it is possible to do away with the blockages caused by the turns binding on an internal calibration means and that the edges of the turns can be adjusted precisely in order to make them contiguous. The tube thus produced has an even surface without gaps and with no overlapping edges of turns, something which improves the quality of the reinforcing strip obtained while the tube has been flattened.

The presence of the interleaf makes it easier for the tube to slide through the calibrating means.

The device therefore comprises a separation means positioned downstream of the said second means and able to separate the said interleaf from the surface of the flattened tube.

The calibrating means may usefully adopt the form of a tubular element of given length the axis of which corresponds substantially to the axis of rotation of the first means with respect to the second means.

The invention also relates to the method which consists in implementing the device according to the invention. This method makes it possible to create a reinforcing strip formed by flattening a tube, the said tube being itself formed by winding a tape in contiguous turns about itself and removing the interleaf.

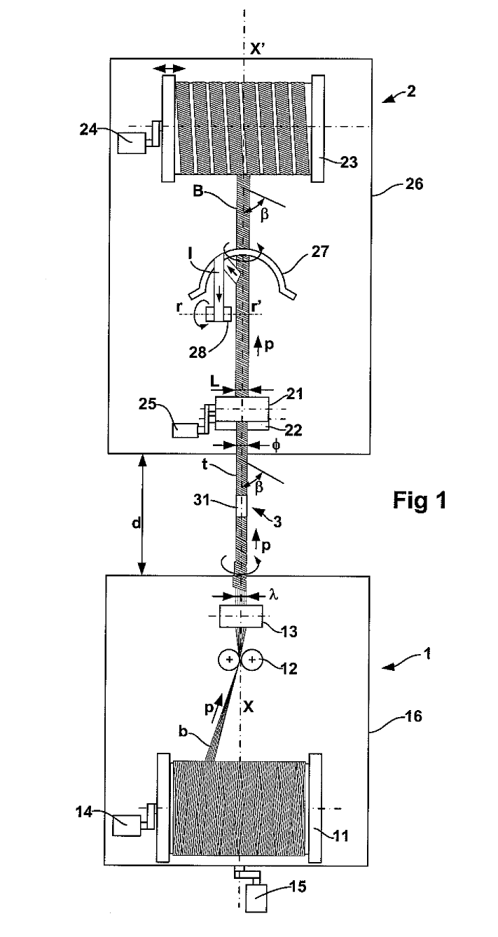

The description which follows, which is supported by a preferred embodiment of the invention and supported by FIGS. 1 to 5 in which:

FIG. 1 depicts a schematic overview of the device according to the invention,

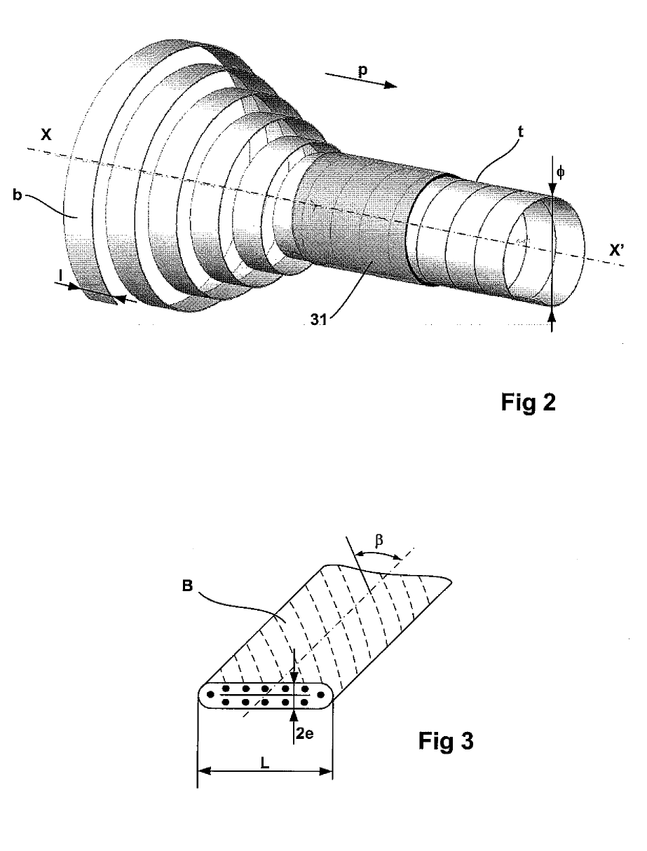

FIG. 2 depicts a schematic view of the tube formed by winding turns contiguously and of the calibrating device,

FIG. 3 depicts a schematic view of a reinforcing strip obtained by implementing the device according to the invention, and

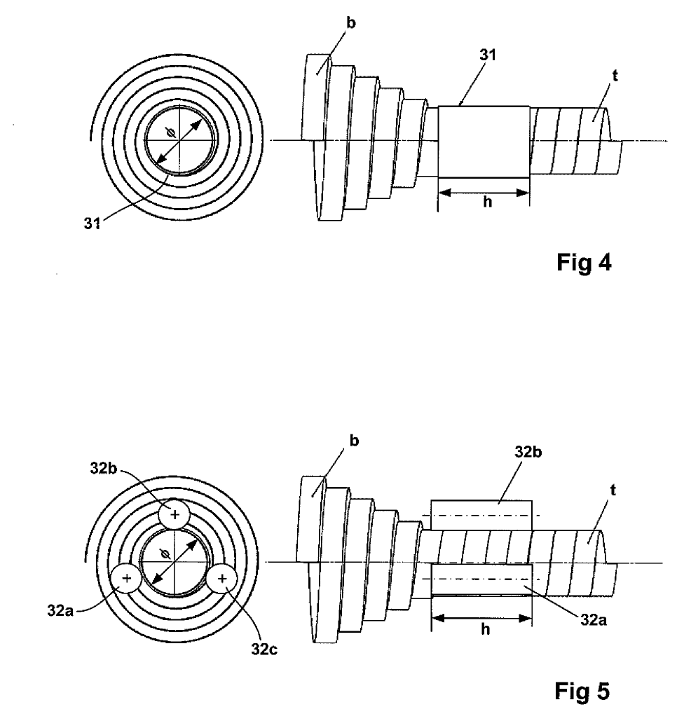

FIGS. 4 and 5 depict schematic views of two embodiments of the calibrating means.

The device illustrated in FIG. 1 comprises a first means 1, which comprises a paying-out device motorized by a motor 14. A continuous tape b of width λ is wound on the pay-out reel 11.

For preference, the reinforcing tape is made up of mutually parallel reinforcing threads coated with a rubber compound; however, the device according to the invention is able to use any kind of tape without their being any need for any substantial modification to the type of means of which it is composed.

Means 12, 13 guide the tape b as it leaves the paying-out device to align the direction in which the tape b progresses with the axis XX′ about which the tape b is wound in a spiral. These means are formed by two sets of rolls the axes of rotation of which are perpendicular. The elements that make up the first means are positioned on a first chassis 16.

The device also comprises a second means 2 comprising two cylinders 21, 22 which are motorized using a motor 25 and able to flatten the tube t to form the reinforcing strip B.

The separation means is formed of a direction-change guide tube (27) of semicircular shape positioned in a plane perpendicular to the axis XX′. This direction-change guide tube rotates about the said axis XX′. The speed at which the separation means rotates is adjusted according to the speed at which the flattened tube advances so that each revelation of the direction-change guide tube corresponds to an advance of the strip B by one complete turn.

The separation means also comprises a roll (28) on which to collect the interleaf (I). This collecting roll accompanies the direction-change guide tube 27 in its rotation about the axis XX′. The collecting roll is itself rotated about an axis rr′ in such a way. The tension at which the interleaf is wound around the collecting roll is adjusted in such a way as to detach the said interleaf I from the surface of the flattened tube.

The second means also comprises a device 23 for storing the reinforcing strip, in this particular instance a reel driven by a motor 24.

The elements that make up the second means are arranged on a second chassis 26 independent of the first chassis 16.

The device finally comprises means able to set the first chassis 16 and the elements it contains in rotation about the axis XX′ with respect to the second chassis 26 and the elements it contains. According to the exemplary embodiment illustrated in FIG. 1, a motor 15 sets the first chassis 1 in rotation about the axis XX′, the second chassis 2 being fixed; it is equally possible to set the second chassis in rotation and to keep the first chassis fixed.

A calibrating means 3 is placed between the two chassis and is preferably secured to the chassis that remains fixed, in this particular instance, the chassis 26 supporting the second means 2. For preference, the calibrating means 3 is secured to the fixed means, in this particular instance to the first means 1.

The way in which the conversion of the tape takes place within the device as illustrated in FIG. 1 is as follows. The tape b from the pay-out device 11, is aligned with the axis XX′ using the guide means 12, 13. Under the effect of the chassis 16 rotating about the axis XX′ the tape b is wound in a spiral on itself. The tube then enters the calibrating means 3 to ensure that the turns are perfectly contiguous to form a tube t of diameter (I). The tube t then passes between the rolls 21 and 22 between which it is flattened to form a reinforcing strip B of width L. The reinforcing strip B is wound onto the reel 23.

The calibrating means 3 is formed of a tubular element 31 of given length h the axis of which corresponds substantially to the axis XX′ of rotation of the first means 1 with respect to the second means 2, as illustrated in FIG. 4. The inside diameter of the tube corresponds substantially to the diameter (I) that the tube t is to have. Thus, on entering the tube, the turns formed by the tape b are forced to come into contact with one another in such a way as to form a tube t of perfectly cylindrical shape on leaving the calibrating means 3, as has been illustrated in FIG. 2. The axis of the tube t coincides with the axis XX′.

It will be seen that the creation of the said tube is highly sensitive to the longitudinal tension likely to be applied to the tape or to the tube t.

Thus, it is possible to improve the formation of the contiguous turns by setting the tube t in rotation about the axis XX′. The direction of rotation is the same as that imposed on the first chassis 16 by the motor 15.

As an alternative, the calibrating means 3 may be formed of least three cylindrical rolls arranged around the tube t, as depicted in FIG. 5. The axes of rotation of the rolls are parallel to the axis XX′ of rotation of the first means 1 with respect to the second means 2.

Steps are then taken to ensure that the said cylindrical rolls (32a, 32b, 32c) are arranged with respect to one another in such a way that the polygon passing through the points of intersection of the axes of the rolls with a plane perpendicular to the axis XX′ is a regular polygon, and that the diameter of the circle passing through the intersection with the said plane of the generatrixes of the rolls in contact with the tube t corresponds to the diameter φ that the tube t is to have, as depicted in FIG. 5; in this particular instance, the rolls illustrated in FIG. 5 are arranged in such a way as to form an equilateral triangle. By extension, the axis of the rolls will thus be positioned on the vertices of a square in the event of a configuration in which the use of four rolls is planned.

In a way similar to that which was stated hereinabove, it is possible to set the cylindrical rolls (32a, 32b, 32c) in rotation about their axis to make it easier to form contiguous turns to which the tube t is formed. It is also possible to set the cylindrical rolls in rotation about the axis XX′.

So, although they are more complicated to use, the rolls have the advantage, because they can be set in rotation, of reducing friction between the external surface of the tube and the calibrating means and therefore of minimizing the longitudinal tensions that are liable to impede the joining-together of the turns edge to edge to form an even tube.

It stems from the foregoing that contact between the external surface of the tube t and the calibrating means 3 has to be applied to a stretch of tube of given length h and has to occur along the circumference of the tube so that the projection of these points of contact in a plane perpendicular to the axis XX′ lie at the vertices of a regular polygon. The circle passing through these points has substantially the diameter (I) of the tube t.

It will be seen that increasing the number of vertices of the polygon then delineates a circle, similar to that which occurs when use is made of a tubular element 31.

The length h of the calibrating means is determined by experience and may usefully range between 3 and 5 times the value of the diameter (I) of the tube t.

The reinforcing strip B that is to be obtained is defined by its width L and by the angle β that the edges of the turns of the tape make with the longitudinal direction of the strip. When the tape b comprises reinforcing threads the strip B is then defined as a function of the angle β formed by the reinforcing threads with the longitudinal direction, as illustrated in FIG. 3. Because the turns are contiguous and for a tape b of thickness e, these parameters will directly determine the width λ of the tape b that has to be produced, according to a relationship of the type λ=2(L−2e+πe) cos β, and the outside diameter φ of the tube t is determined by the relationship

$$φ = \frac{2 L - 4 e + 2 π e}{π} .$$

It then follows that, in order to ensure that the tube t is formed evenly and to prevent any longitudinal tension liable to disrupt the formation of the turns, the longitudinal speeds of the product between the first and the second means need to be regulated very precisely so that the ratio between the linear speed at which the tube t enters the second means 2 and the linear speed at which the tape b leaves the first means 1 is substantially equal to the sine of the angle β.

To do this, appropriate means are used to influence the motor 14 that rotates the paying-out device 11, to influence the motor 25 that drives the cylinders 21 and 22 and to influence the motor 24 that drives the reel 24. As an option, it is also possible to plan to have the rolls 12 and 13 motorized.

Finally, steps are taken to ensure that the distance d between the first and the second means is as short as possible so as to avoid longitudinal tension associated with the action of gravity on the tape b.

With a view to reducing longitudinal tension, it is also possible to encourage the tape to slide inside the tube. This can be achieved by covering that face of the tape (b) that is intended to be brought into contact with the internal part of the calibrating means (3) with a thin layer of interleaf material that can be readily detached from the rubbery compound. In practice, the said thin layer is formed of the interleaf material used to prevent rubbery materials from sticking together when the said materials are placed in a storage means in which they are superposed on one another.

The interleaf is placed on one of the faces of the rubbery material that is to be protected. The layer of interleaf material prevents non-vulcanized rubbery materials which have a natural tendency to stick firmly together when brought into contact with one another from coming into contact with one another. Hence, the material of which the interleaf is made has to have particular properties of adhesion with respect to the rubbery compound. Specifically, it has to remain attached to that face of the rubbery material that it protects when the said rubbery material is taken out of stock. It has therefore to separate easily from the other rubbery materials which, through it presence, have been prevented from coming into contact with the material that is to be protected. Moreover, it has also to be readily separable from the said rubbery material that it protects when, for example when building up a green tire, it is desirable for said rubbery material to be used without its interleaf. What is meant by “readily separable” is the fact that the mechanical effort that has to be applied in order to detach the interleaf from the rubbery materials should not lead to any geometric deformation of the said rubbery materials with which the interleaf has been brought into contact.

Typically, in the context of the application to the implementation of the invention when seeking to create a rubbery reinforcement, the interleaf material is placed on one of the faces of the tape b so as to allow the tape to be stored on a reel 11 in which several layers of tape are superimposed on one another. Experts in the rubber industry are aware of a wide variety of materials that may be suitable for an interleaf, these including, by way of example, thermoplastics of the polyethylene type or alternatively, textile materials based on cotton fibres.

The use of this device is particularly well suited to the creation of reinforcing strips B formed from a tape b comprising reinforcing threads and intended for the production of tires. However, it is also possible, without departing from the invention, to use the device to create all kinds of strip from tapes of all sorts as explained in the foregoing.

1. A device for creating a reinforcing strip formed by flattening a tube comprising:
a first means for dispensing a tape comprising an interleaf on one of its faces, at a given linear speed;
second means comprising two rolls adapted to flatten the tube, wherein said first and second means are configured to be set in rotation relative to one another about an axis of rotation parallel to a direction in which the tape progresses through the device, so that when the device is operating, the tape is wound in a spiral on itself in contiguous turns to form a tube the axis of which corresponds substantially to the axis of rotation of the first means with respect to the second means;
a means for calibrating the diameter of the tube and positioned between the first and second means, such that, when the device is in operation said calibration means rests against an exterior surface of the tube on which surface said interleaf is positioned; and
separation means positioned downstream of said second means and able to separate said interleaf from the surface of the flattened tube.

2. The device according to claim 1, wherein the calibration means is formed of a cylindrical tubular element of given length the axis of which corresponds substantially to the axis of rotation of the first means with respect to the second means and the inside diameter of which corresponds substantially to the outside diameter that the tube is to have.

3. The device according to claim 1, wherein the calibration means is able to be set in rotation about its axis parallel to the axis of rotation of the first means with respect to the second means.

4. The device according to claim 1, wherein the calibrating means is formed of at least three cylindrical rolls of given length and the axes of which are parallel to the axis of rotation of the first means with respect to the second means.

5. The device according to claim 4, wherein the rolls are positioned relative to one another in such a way that the polygon passing through the points of intersection of the axes of the rolls with a plane perpendicular to the axis XX′ is a regular polygon, and wherein the diameter of the circle passing through the intersection with said plane of the generatrixes of the rolls in contact with the tube corresponds to the diameter that the tube is to have.

6. The device according to claim 4, wherein the rolls are adapted to be set in rotation with respect to the axis of rotation of the first means with respect to the second means.

7. The device according to claim 4, wherein each of the rolls is adapted to be set in rotation about its axis parallel to the axis of rotation of the first means with respect to the second means.

8. The device according to claim 2, wherein the value of the length of the calibration means ranges between 3 and 5 times the value of the outside diameter of the tube.

9. The device according to claim 1, wherein said separation means is formed of a direction-change guide tube of semicircular shape positioned in a plane perpendicular to the axis of rotation of the first means with respect to the second means and effecting a rotational movement about the axis.

10. A method of producing a reinforcing strip formed by flattening a tube, the tube being itself formed by winding a tape upon itself in contiguous turns, wherein the method comprises implementing a device according to claim 1, and the axis of the tube being the axis of rotation of the first means with respect to the second means.

11. The method according to claim 10, wherein before the tube is flattened, its outside diameter is adjusted to make the turns of the tape contiguous by causing the tube to run along inside a calibrating means so that the contacts between the external surface of the tube and the calibrating means are applied to a stretch of tube of given length and occur along the circumference of the tube such that the projection of these points of contact in a plane perpendicular to the axis of the tube lie at the vertices of a regular polygon.

12. The method according to claim 11, wherein the tape is formed of a web of mutually parallel reinforcing threads directed in the longitudinal direction of the tape and coated with a rubber-type compound.

13. The method according to claim 12, wherein the reinforcing strip comprises two layers of threads which layers are superposed on one another, where the reinforcing threads of one layer are mutually parallel and the reinforcing threads of different layers make opposite angles with the reinforcing strip, and wherein the threads run on continuously from one layer to another.

14. The method according to claim 13, wherein the width of the tape is determined as a function of the width and of the angular orientation of the threads of the reinforcing strip that is to be produced.

15. The method according to claim 14, wherein the longitudinal speeds of the product between the first and the second means are regulated so that the ratio between the linear speed at which the tube enters the second means and the linear speed at which the tape leaves the first means is substantially equal to the sine of the angular orientation of the threads of the reinforcing strip.
